(19) United States
(12) Patent Application Publication
(10) Pub. No.: US 2015/0296386 A1
(43) Pub. Date: Oct. 15, 2015

(54) SYSTEM AND METHOD FOR SPECTRUM SHARING

(71) Applicant: EDEN ROCK COMMUNICATIONS, LLC, Bothell, WA (US)

(72) Inventors: Rekha MENON, Bothell, WA (US); Jungnam YUN, Bothell, WA (US); Eamonn GORMLEY, Bothell, WA (US)

(21) Appl. No.: 14/687,872

(22) Filed: Apr. 15, 2015

Related U.S. Application Data
(60) Provisional application No. 61/979,680, filed on Apr. 15, 2014.

(51) Int. Cl. H04W 16/14; H04W 16/18; H04W 24/08; H04W 4/02; H04J 11/00

(52) U.S. Cl. CPC H04W 16/14; H04W 4/021; H04J 11/005; H04W 24/08; H04W 16/18

(57) ABSTRACT

A method for spectrum coexistence includes determining interference from a primary network to a secondary network that is independent from the primary network, determining transmission parameters for a network element of the secondary network that mitigate interference from the secondary network to the primary network, and transmitting signals from the network element according to the determined transmission parameters. The network element could be a base station or user equipment. Accordingly, a secondary network can coexist with a primary network even when the networks do not communicate with each other.

### CROSS-REFERENCES TO RELATED APPLICATIONS

The present invention claims priority to U.S. Provisional Application No. 61/979,680, filed Apr. 15, 2014, which is incorporated by reference herein for all purposes.

This invention was made with government support under contract number N0001413C0194 awarded by the Office of Naval Research. The government has certain rights in the invention.

### BACKGROUND

Radio Frequency (RF) spectrum is a limited and extremely valuable resource. The amount of data transmitted wirelessly has been increasing exponentially in recent years. While technology has been evolving to make more efficient use of the limited RF spectrum available to certain technologies, the demand for spectrum resources has exceeded the improvements from those efficiencies.

The RF spectrum is typically constrained by local laws and regulations. The regulations generally allocate portions of the spectrum to certain technologies. For example, governments generally set aside particular portions of the spectrum for emergency and military services, television broadcasts, satellite transmissions, etc. Some of the services that occupy portions of the spectrum do not fully utilize those portions of the spectrum.

For example, a portion of the spectrum allocated for military purposes may be used extensively at a military site, but only have limited use in civilian areas. Similarly, while a portion of the spectrum allocated for television broadcasts may be sufficient to simultaneously handle up to 100 channels, only a few channels may be present in a particular location at a given time. Thus, while portions of the RF spectrum are highly loaded, other portions of the frequency spectrum are under-utilized.

### BRIEF SUMMARY

Embodiments of the present disclosure relate to a system and method for radio frequency (RF) spectrum sharing between primary and secondary users. Aspects of the present disclosure may be implemented as a method, a system, or an apparatus.

In an embodiment, a spectrum coexistence method includes determining interference from a primary network to a secondary network that is independent from the primary network, determining transmission parameters for a network element of the secondary network that mitigate interference from the secondary network to the primary network, and transmitting signals from the network element according to the determined transmission parameters. Determining interference to the secondary network may include searching a database of external interference, and the database of external interference may include data for a plurality of predetermined interference sources that are known to transmit RF signals that interfere with the secondary network.

Determining interference to the secondary network may include measuring, by an element of the secondary network, signals that interfere with the secondary network, and classifying the measured signals by one or more characteristic of the signals. The classified signal can be used to determine the transmission parameters. The method may include adding the classified signal to the database of external interference.

In an embodiment, determining interference from the primary network includes localizing a source of the interference by a geolocation engine of the secondary network. Determining transmission parameters may include applying a spectrum policy from a spectrum policy database of the first network, and determining transmission parameters may include performing a simulation with an RF coverage prediction engine included in the secondary network.

Determining the interference and determining transmission parameters for the network element can be performed by a central network element using information from an Operation, Administration and Maintenance system, and the central network element is coupled to a plurality of base stations through low latency connections. In another embodiment, performing determining transmission parameters is distributed between a plurality of Self Organizing Network (SON) agents disposed at various network elements based on spectrum policy parameters stored at a central network element.

### BRIEF DESCRIPTION OF THE DRAWINGS

FIG. 1 illustrates an embodiment of a wireless communications network.

FIG. 2 illustrates an embodiment of a network resource controller.

FIG. 3 illustrates a secondary network in the presence of primary networks.

FIG. 4 illustrates an embodiment of a Spectrum Coexistence Self Organizing Network (SC-SON) device.

FIG. 5 illustrates an embodiment of an LTE communications system.

FIG. 6 illustrates an embodiment of a centralized SC-SON system.

FIG. 7 illustrates an embodiment of a hybrid SC-SON system.

FIG. 8 illustrates an embodiment of a spectrum coexistence method.

### DETAILED DESCRIPTION

Spectrum sharing is a promising technology to address the growing demand for mobile data in commercial wireless networks. Self Organizing Network (SON) systems, already widely adopted by operator and standards bodies to manage and optimize commercial wireless networks, are particularly well suited for implementing spectrum sharing techniques. Accordingly, embodiments of this disclosure relate to a SON system, referred to here as the Spectrum-Coexistence SON (SC-SON), that enables wireless networks to share spectrum with other users.

In an embodiment, an SC-SON enables a wireless cellular communications network to share spectrum with a network that may or may not be based on a cellular telecommunications technology, such as broadcast network, radar network, and wireless device communication network. The SC-SON may be flexible enough that the wireless telecommunications network could be either a primary or a secondary user of the spectrum.

In an embodiment, a primary network is an original occupant of a portion of frequency spectrum that is shared by a secondary network, however, embodiments are not limited thereto. A primary user may be given precedence over a secondary user when sharing spectrum. For example, a primary user may be an emergency broadcast system which is given priority over a cellular telecommunications network that is a secondary user. Various embodiments of a SC-SON system may be implemented as a centralized system or a hybrid system.

Embodiments of this disclosure can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of embodiments is provided below along with accompanying figures. The scope of this disclosure is limited only by the claims and encompasses numerous alternatives, modifications and equivalents. Numerous specific details are set forth in the following description in order to provide a thorough understanding. These details are provided for the purpose of example and embodiments may be practiced according to the claims without some or all of these specific details. For the purpose of clarity, technical material that is known in the technical fields related to this disclosure have not been described in detail so that this disclosure is not unnecessarily obscured.

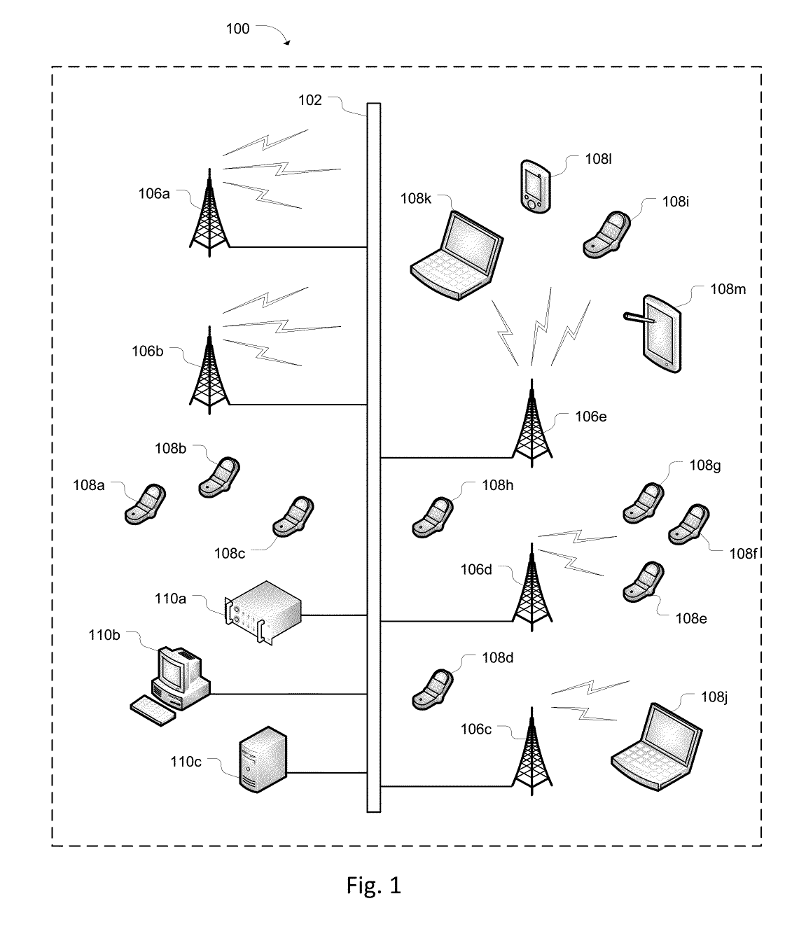

FIG. 1 illustrates a networked communications system 100 according to an embodiment of this disclosure. As depicted, system 100 includes a data communications network 102, one or more base stations 106a-e, one or more network resource controller 110a-c, and one or more User Equipment (UE) 108a-m. As used herein, the term “base station” refers to a wireless communications station provided in a location and serves as a hub of a wireless network. The base stations may include macrocells, microcells, picocells, and femtocells.

In a network 100 according to an embodiment, the data communications network may include a backhaul portion that can facilitate distributed network communications between any of the network controller devices 110a-c and any of the base stations 106a-e. Any of the network controller devices 110a-c may be a dedicated Network Resource Controller (NRC) that is provided remotely from the base stations or provided at the base station. Any of the network controller devices 110a-c may be a non-dedicated device that provides NRC functionality among others. The one or more UE 108a-m may include cell phone devices 108a-i, laptop computers 108j-k, handheld gaming units 108l, electronic book devices or tablet PCs 108m, and any other type of common portable wireless computing device that may be provided with wireless communications service by any of the base stations 106a-e.

As would be understood by those skilled in the Art, in most digital communications networks, the backhaul portion 102 of a data communications network 100 may include intermediate links between a backbone of the network which are generally wire line, and sub networks or base stations 106a-e located at the periphery of the network. For example, cellular user equipment (e.g., any of UE 108a-m) communicating with one or more base stations 106a-e may constitute a local sub network. The network connection between any of the base stations 106a-e and the rest of the world may initiate with a link to the backhaul portion of an access provider's communications network (e.g., via a point of presence).

In an embodiment, an NRC has presence and functionality that may be defined by the processes it is capable of carrying out. Accordingly, the conceptual entity that is the NRC may be generally defined by its role in performing processes associated with embodiments of the present disclosure. Therefore, depending on the particular embodiment, the NRC entity may be considered to be either a hardware component, and/or a software component that is stored in computer readable media such as volatile or non-volatile memories of one or more communicating device(s) within the network 100.

In an embodiment, any of the network controller devices 110a-c and/or base stations 106a-e may function independently or collaboratively to implement processes associated with various embodiments of the present disclosure.

In accordance with a standard GSM network, any of the network controller devices 110a-c (NRC devices or other devices optionally having NRC functionality) may be associated with a base station controller (BSC), a mobile switching center (MSC), a data scheduler, or any other common service provider control device known in the art, such as a radio resource manager (RRM). In accordance with a standard UMTS network, any of the network controller devices 110a-c (optionally having NRC functionality) may be associated with a NRC, a serving GPRS support node (SGSN), or any other common network controller device known in the art, such as an RRM. In accordance with a standard LTE network, any of the network controller devices 110a-c (optionally having NRC functionality) may be associated with an eNodeB base station, a mobility management entity (MME), or any other common network controller device known in the art, such as an RRM.

In an embodiment, any of the network controller devices 110a-c, the base stations 106a-e, as well as any of the UE 108a-m may be configured to run any well-known operating system, including, but not limited to: Microsoft® Windows®, Mac OS®, Google® Chrome®, Linux®, Unix®, or any mobile operating system, including Symbian®, Palm®, Windows Mobile®, Google® Android®, Mobile Linux®, etc. Any of the network controller devices 110a-c, or any of the base stations 106a-e may employ any number of common server, desktop, laptop, and personal computing devices.

In an embodiment, any of the UE 108a-m may be associated with any combination of common mobile computing devices (e.g., laptop computers, tablet computers, cellular phones, handheld gaming units, electronic book devices, personal music players, MiFi™ devices, video recorders, etc.), having wireless communications capabilities employing any common wireless data communications technology, including, but not limited to: GSM, UMTS, 3GPP LTE, LTE Advanced, WiMAX, etc.

In an embodiment, the backhaul portion 102 of the data communications network 100 of FIG. 1 may employ any of the following common communications technologies: optical fiber, coaxial cable, twisted pair cable, Ethernet cable, and power-line cable, along with any other wireless communication technology known in the art. In context with various embodiments of the invention, it should be understood that wireless communications coverage associated with various data communication technologies (e.g., base stations 106a-e) typically vary between different service provider networks based on the type of network and the system infrastructure deployed within a particular region of a network (e.g., differences between GSM, UMTS, LTE, LTE Advanced, and WiMAX based networks and the technologies deployed in each network type).

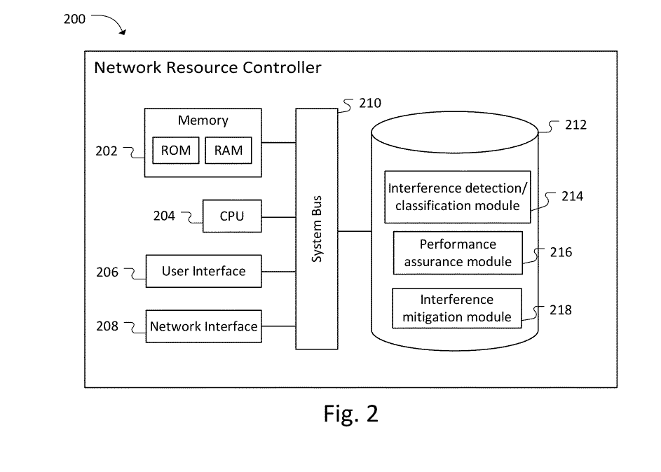

FIG. 2 illustrates a block diagram of an NRC 200 that may be representative of any of the network controller devices 110a-c. Accordingly, NRC 200 may be representative of a Network Manager (NM), an Element Manager (EM), a domain manager (DM), a SON server, etc., that is present in an embodiment of this disclosure. The NRC 200 has one or more processor devices including a CPU 204.

The CPU 204 is responsible for executing computer programs stored on volatile (RAM) and nonvolatile (ROM) memories 202 and a storage device 212 (e.g., HDD or SSD). In some embodiments, storage device 212 may store program instructions as logic hardware such as an ASIC or FPGA. Storage device 212 may store, for example, an interference detection/classification module 214, a performance assurance module 216, and an interference mitigation module 218.

The NRC 200 may also include a user interface 206 that allows an administrator to interact with the NRC's software and hardware resources and to display the performance and operation of the system 100. In addition, the NRC 200 may include a network interface 206 for communicating with other components in the networked computer system, and a system bus 210 that facilitates data communications between the hardware resources of the NRC 200.

In addition to the network controller devices 110a-c, the NRC 200 may be used to implement other types of computer devices, such as an antenna controller, an RF planning engine, a core network element, a database system, or the like. Based on the functionality provided by an NRC, the storage device of such a computer serves as a repository for software and database thereto.

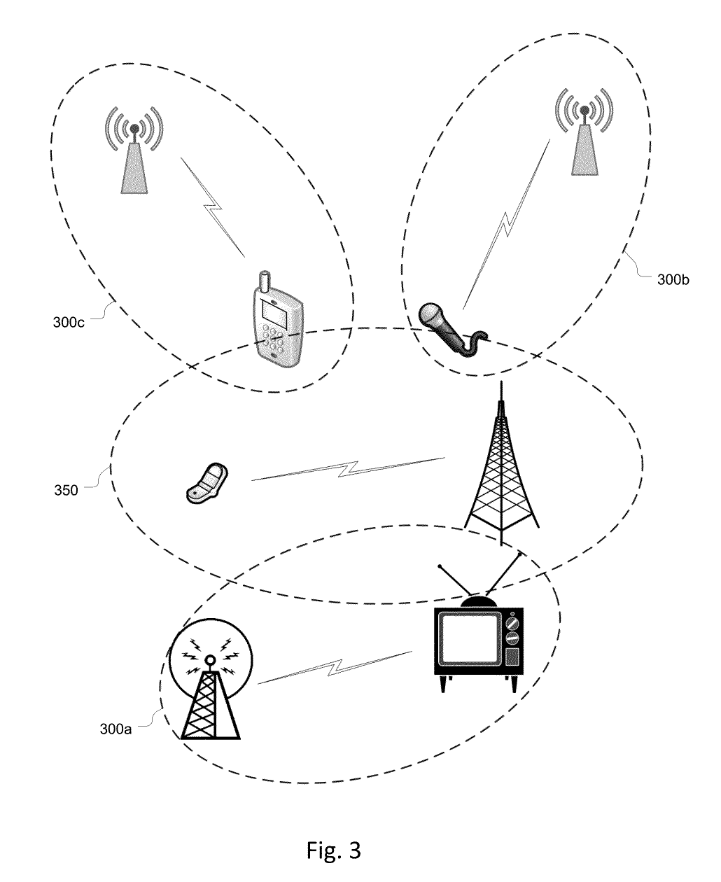

FIG. 3 shows an example of several primary networks 300 which share spectrum with a secondary network 350. The primary networks 300 shown in FIG. 3 are a television network 300a, a wireless microphone network 300b, and an emergency communications network 300c. A primary network may be a broadcast system that covers a relatively large area such as television network 300a, a one-way transmission system such as wireless microphone network 300b, or a bi-directional communications system such as emergency communications network 300c. However, embodiments are not limited to these examples. In other embodiments, other systems that transmit signals in the RF spectrum may be a primary network 300.

The primary network 300 uses portions of the RF spectrum that interfere with secondary network 350. Thus, a primary network 300 may use a portion of the RF spectrum that overlaps with or is near to a portion of the RF spectrum that is used by the secondary network 350. A primary network 300 may be a civilian system or a government system.

The primary network 300 may be established as having primacy for the portion of spectrum that it uses by a government entity. For example, in the United States, television networks 300 are registered with the Federal Communications Commission to have primacy in certain frequency bands. In some jurisdictions, primary networks have exclusive rights to a portion of the RF spectrum. Embodiments of this disclosure facilitate the operation of other RF communication systems in an interfering portion of RF spectrum so that the primary networks maintain primacy in the allocated portion of spectrum. In other words, embodiments facilitate sharing a portion of frequency spectrum between a primary network 300 and a secondary network 350 in a way that minimizes impacts to the primary network 300.

In an embodiment, each of the primary networks 300 are independent from the secondary network 350. In other words, each primary network 300 is autonomous from the secondary network 350. Accordingly, the primary networks 300 are operated and controlled separately from the secondary network 350. Therefore, according to embodiments of this disclosure, a primary network 300 may operate normally without any accommodation for a secondary network 350, while the secondary network adapts to minimize interference to and accept interference from the primary network 300.

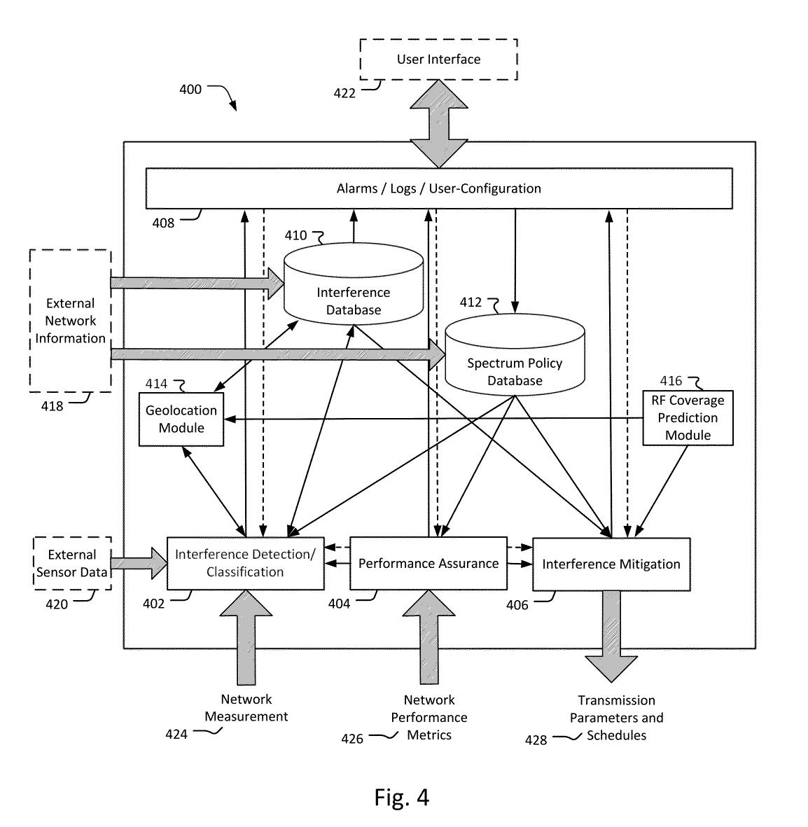

FIG. 4 shows an embodiment of a Spectrum Coexistence Self-Organizing Network (SC-SON) system 400. The primary network 400 includes three key modules: an interference and detection module 402, a performance assurance module 404, and an interference mitigation module 406. Each of the modules may be disposed in a single physical location, or elements of one or more module may be distributed across multiple physical locations or entities.

In an embodiment, a module is a set of computer executable instructions that is stored on a computer readable medium. In another embodiment, one or more aspect of a given module is a hard-coded circuit such as an application-specific integrated circuit (ASIC) or field-programmable gate array (FPGA). In still another embodiment, a module includes both hard coded circuits and computer readable media.

The main control interfaces in the SC-SON system are shown using dotted arrows in FIG. 4. Accordingly, the user configuration module 408 may be used to initiate operation of the interference and detection module 402, an interference mitigation module 404, and performance assurance module 406. Similarly, the performance assurance module 404 can be used to initiate the interference detection module 402 and the interference mitigation module 406.

The SC-SON system 400 may include an interference database 410. The interference database 410 may be internally maintained by the SC-SON system 400. In an embodiment, the interference database 410 is populated by data from an external spectrum access managing entity, such as a spectrum access database, that provides information about the location and transmission characteristics of primary users of the spectrum.

For example, when a primary user to be managed by the SC-SON system 400 is a television network 300a, the SC-SON system 400 could query a white space database and store information about broadcast station locations, frequencies, transmission powers, and white spaces between channels as they exist in the vicinity of secondary network 350. A non-exhaustive list of information that may be stored in the interference database 410 includes transmitter location, transmission power, transmission frequencies, transmission times, signal characteristics at various locations other than the source of the transmissions, pointing directions of antennas, and spatial signatures of one or more primary and secondary networks 300 and 350.

Information in database 410 may come from a variety of sources. For example, an entity that manages RF spectrum may maintain lists of approved installations at various locations, which is one possible source. Other sources are manual entry and polling of various external databases. Examples of spectrum databases that may be polled in the United States include the FCC's TV White Space Database, and the Spectrum Database maintained by GOOGLE™.

Information in the interference database 410 may be augmented with information from the interference detection and classification module 402. For example the SC-SON system 400 may detect the presence of a wireless microphone that does not appear in an external database. In such a case, interference database 410 may be updated to include information for the detected wireless microphone.

The SC-SON system 400 may include a spectrum policy database 412 which may include policy control and functional objectives for the operation of the interference detection, performance assurance, and interference mitigation modules 402, 404 and 406. For example, spectrum policy database 412 may include times and locations for which interference detection mechanisms are activated, performance thresholds for the primary network 300 and the secondary network 350, and performance goals of the interference mitigation techniques. More specifically, the spectrum policy database 412 may include QoS targets for the primary network 300 that may be achieved by mitigation applied to the secondary network 350.

The spectrum policy database 412 may receive inputs from an external spectrum access managing entity or be configured by an operator. For example, in the TV white space scenario, information in the spectrum policy database could be derived from certified TV white space databases and could include restrictions on the maximum allowable transmit power or coverage region of the transmission nodes of the secondary network 350.

The interference detection/classification module 402 coordinates the transmission and RF measurement at network elements to isolate and detect interference caused by external sources from intra-system interference caused by network elements. For example, module 402 may schedule quiet times in a communications network and measure signals received during those quiet times.

In addition, interference detection/classification module 402 may collate measurements 424 from distributed network elements to build an interference fingerprint that can be used to classify the interferer. The interference fingerprint may be developed from a pattern of times, frequencies, and strengths of received signals. If available, the SC-SON system 400 may collect and collate external sensor data 420 from external sensor networks as well.

The interference detection/classification module 402 may interface with the interference database 410. Information about interferers from the database 410 may be used in the interference classification process. For example, interference features may be compared to features of interferers that are known to exist in the vicinity of the SC-SON system 400 to identify the interferers. When an unknown interferer's fingerprint matches characteristics of a known interferer, module 402 may determine that the unknown interferer is the same type of entity as the known interferer.

Once new interferers are classified in the interference detection/classification module 402, information about the interferers may be added to the interference database 410. Therefore the module may use information from the interference database 410 as well as augment information in the interference database 410.

Measurement data 424 collected by the interference detection/classification module 402 may be also be processed by a Geolocation module 414 in the SC-SON system 400 to localize the interferer source. When available, location information can be helpful in further characterizing and classifying an interferer. For example it may be known or otherwise assumed that wireless microphones are the only type of interferer present in a particular region. If geolocation information shows that an un-classified interferer is from this region, then the interferer can be assumed to be a wireless microphone.

When geolocation information for interferers is available, the geolocation information may be added to the interference database 410. When interference is detected, the module 410 may interface with an alarm subsystem 408 to report the interferer.

The operation of the interference detection/classification module 402 may be initiated by a user from the user-configuration module 408. The user may configure interference module 402 to be run once, periodically or continually. The operation of the module 402 may also be initiated by the performance assurance module 404 when it perceives irregularities in performance metrics 426.

In an embodiment, the performance assurance module 404 subsystem retrieves performance data 426 from a secondary network 350 and builds and analyzes KPI trends to detect the presence of interference. In addition, module 404 may monitor the performance of implemented interference mitigation strategies.

If the presence of interference is indicated by anomalies in the KPI trends, the interference detection and classification module 402 may be triggered to detect and classify the source of the interference. KPI trends themselves may also be used by the interference detection and classification module in characterizing certain types of interferers. For example, performance degradations that periodically repeat may represent interference from a pulsed transmission source such as a Radar system.

The performance assurance module 404 may also interface with the alarm module 408 and external reporting modules to report any anomalies in expected KPI trends. The operation of performance assurance module 404 may be initiated by the user from the user-configuration module 408. The user may configure the module 404 to be run once, periodically or continually.

The interference mitigation module 406 uses information about the detected and classified interference sources from the interference database 410 to dynamically optimize the configuration of a secondary network 350 to minimize the effect of interference from the secondary network 350 on a primary network 300. The interference mitigation module 406 then pushes the optimized configuration parameters to the secondary network 350. Interference mitigation module 406 may also interface with an RF coverage prediction tool 416 to analyze the impact of interference on the primary or secondary network 300 or the secondary network 350, as well as to predict the impact of particular interference mitigation adaptations before pushing changes to network equipment.

Operations of the interference mitigation module 406 may be periodically logged and reported to a user via the user-configuration module 408. The operation of interference mitigation module 406 may be initiated by the user from the user-configuration module 408. The user may configure mitigation module 406 to be run once, periodically or continually. The user may also configure the interference mitigation module to run every time that a new interferer is added to the interference database 410.

The Geolocation module 414 may allow other SC-SON modules to localize transmission nodes using measurements of their RF energy from distributed nodes within the network.

In an embodiment, the Geolocation module 414 is a server-based implementation with a well-defined API through which other SC-SON modules can dynamically initiate and receive location estimates based on RF measurements. In an embodiment, Geolocation module 414 is a generalized implementation that may be used for both geo-locating network nodes such as user equipment (UEs) and external interferers within a network. In another embodiment, Geolocation module 414 is a module that is used specifically for geo-locating external interferers. RF coverage prediction module 416 allows SC-SON modules to perform run-time RF predictions of specific scenarios, and the results of these predictions may be used within the decision logic of various modules. Various configuration parameters of base stations may be tested by the coverage prediction module 416 to evaluate the potential impact of changes to the configuration parameters.

In an embodiment, the RF coverage prediction module 416 is a server-based implementation that has a well-defined API through which other SC-SON modules can dynamically initiate and receive results for portions of the network. The RF prediction module 416 may incorporate 2D and 3D ray-tracing capability and outdoor to indoor coverage models. For refined accuracy, the propagation models may consider the attenuation and height of clutter databases at the receiver location or at each study point (point or pass-through clutter attenuation options) as well as 3D vector building databases for dense urban modeling.

With reference to the SC-SON system 400, the Geolocation module 414 and the interference mitigation module 406 may leverage results from various sources such as the dynamic RF coverage prediction analysis performed by RF coverage prediction module 416. As seen in FIG. 4, outputs from Geolocation module 414 may be incorporated into interference database 410, and Geolocation module 414 may receive data from RF coverage prediction module 416, interference database 410 and interference detection and classification module 402 to assist with determining Geolocations.

The alarm/log/user-configuration module 408 provides the external user interface for the SC-SON system 400. The dotted arrows from module 408 to the interference detection and classification module 402, performance assurance module 404 and interference mitigation module 406 indicate that module 408 may allow the operation of the these modules to be configured and initiated by a user. Module 408 may also maintain a log of data reported by the different SC-SON modules including alarms related to the identification of an external interferer. In addition, it may maintain a log of the decisions made by various SC-SON modules. Although FIG. 4 shows the alarm, logging and user-configuration elements as being incorporated into a single module 408, in other embodiments, these elements may be incorporated into discrete modules or combined with other modules.

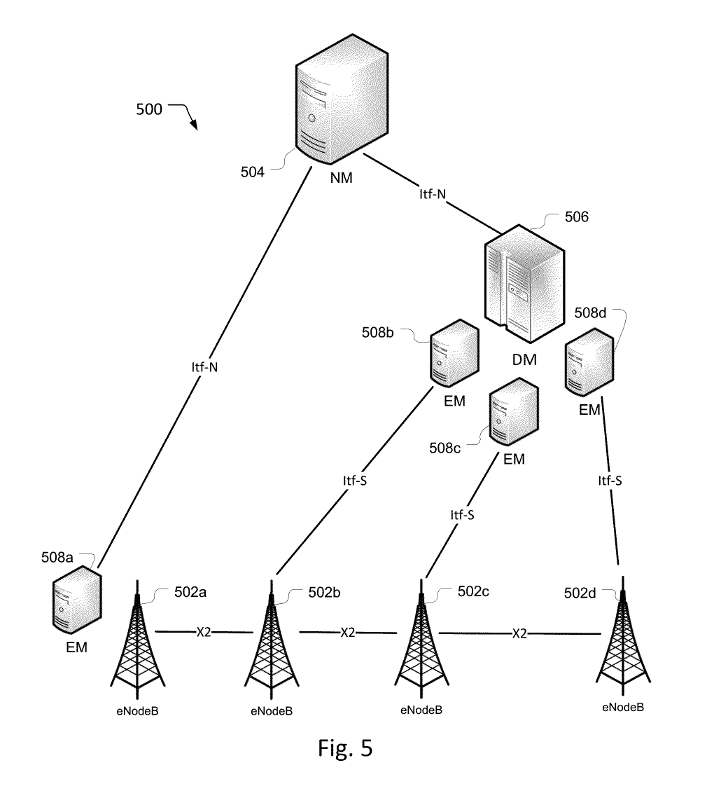

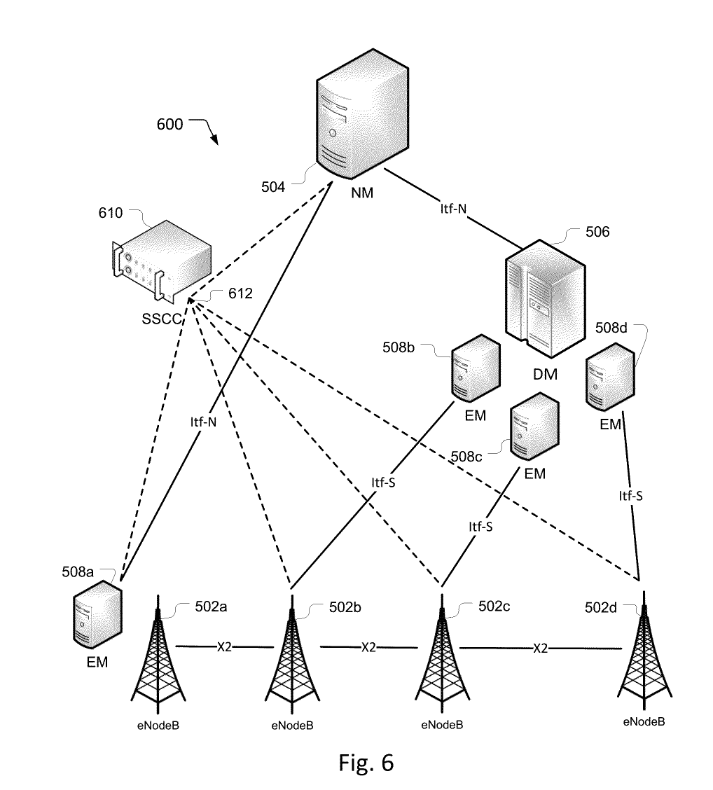

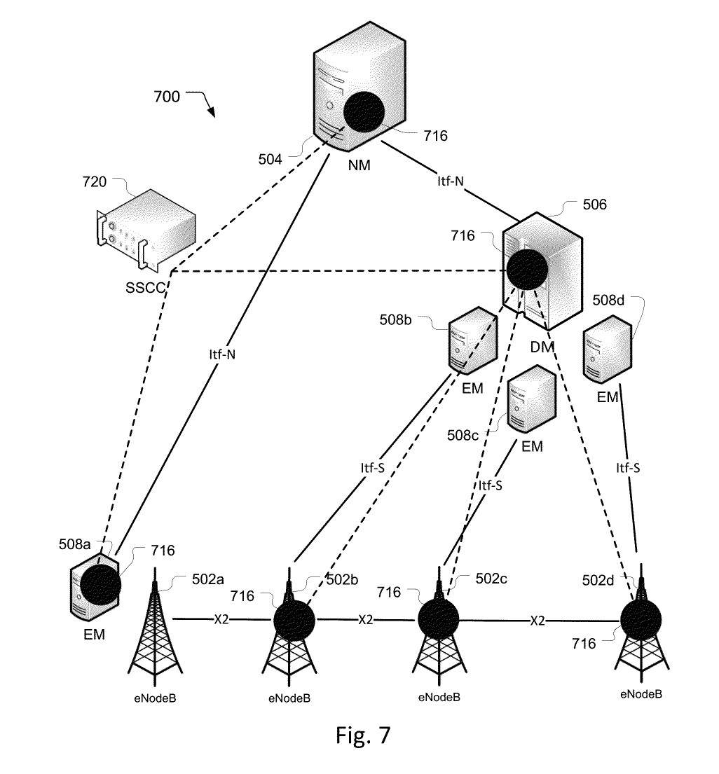

FIG. 5 shows elements of an LTE system 5 that may be involved in implementing an embodiment of the present disclosure. Specific implementations may be described as a centralized embodiment and a hybrid embodiment, which will be explained in more detail with respect to FIGS. 6 and 7. Although the embodiments are described with respect to an LTE system, it should be recognized that the technology in this disclosure applies to other wireless communication technologies as well.

As seen in FIG. 5, an LTE system 500 includes a plurality of base stations 502a-d which are in wireless communication with a plurality of UE. In the embodiment shown in FIG. 5, the base stations 502 are eNodeBs which are directly coupled to one another through a low-latency X2 interface.

In an LTE network, an Operation, Administration and Maintenance (OA&M) system includes of multiple management components such as a Network Manager (NM) 504, a Domain Manager (DM) 506, and Element Managers (EMs) 508a-d. The managers and other aspects of an OA&M system are described in the 3^{rd} Generation Partnership Project (3GPP) Technical Specification (TS) 32.101, version 11.1.0, Release 11 (3rd Generation Partnership Project; Technical Specification Group Services and System Aspects; Telecommunication management; Principles and high level requirements) and 3GPP TS 32.342 version 11.0.0 Release 11 (Digital cellular telecommunications system (Phase 2+); Universal Mobile Telecommunications System (UMTS); LTE; Telecommunication management; File Transfer (FT) Integration Reference Point (IRP); Information Service (IS)).

EMs 508a-d manage a set of related types of network elements. For an LTE network, these network elements include eNodeBs 502. EMs 508 for eNodeBs 502 are typically implemented by eNodeB vendors and may physically reside with each eNodeB 502. However, EMs 508 can also be used to manage a sub-network of eNodeBs 502. A DM 506 manages a sub-network and may provide multi-vendor and multi-technology management functions. A NM 504 manages a network and is typically supported by EMs 508 and DMs 506. NMs 504 typically offer multi-vendor and multi-technology support for underlying EMs508 and network elements.

3GPP defines a standard open interface, Itf-N (Northbound interface) between DMs 506 and an NM 504 and between EMs 508 and the NM 504. A standardized file transfer protocol is also specified for the Itf-N interface to retrieve Configuration Management (CM), Performance Management (PM) and Fault Management (FM) metrics from the EMs 508 and DMs 506 at the NM 504. However, some specific implementations of a northbound interface are vendor specific. The interface between EMs 508 and network elements is called the Itf-S (Southbound interface) and is vendor specific.

FIG. 6 shows an LTE-based embodiment of an LTE-based central SC-SON system 600. In a central SC-SON system 600, the elements of the SC-SON system 400 explained with respect to FIG. 4 are implemented at a central network element 610 of a wireless communications network, which is referred to here as an SC-SON Central Controller (SSCC). In the embodiment shown in FIG. 6, the centralized SC-SON node 610 is a standalone system that interfaces with the OA&M components of an LTE network. In another embodiment (not shown), the SSCC 610 is implemented within the NM 504 of the OA&M system.

In a central SC-SON system 600, various SON interfaces 612, shown as dashed lines in FIG. 6, may be used to directly access data from all network elements including management systems such as NM 504 and EMs 508 and base stations 502. The interfaces 612 may be standardized low latency interfaces to access, for example, measurement data for interference detection and transmission schedule information from base stations 502. In other words, interfaces 612 may be used to transmit data used to implement spectrum sharing from various components of a communications network to SSCC 610.

Interference measurements and performance data from the entire network may be collated at the central node 610 to detect, characterize and localize external interference from a primary network 300. Similarly, these metrics may also be used to identify interference mitigation strategies that are optimal from a global perspective for the LTE network.

The centralized SC-SON node 610 may access CM, PM, FM and event data at the NM 504. If the SC-SON node 610 is implemented within the NM 504, CM, PM, FM and event data may be directly accessed via the EMs 508 and DMs 506 using the Itf-N interface.

However, not all the information required for fast time-scale resource allocation decisions (including transmission schedule information as well as measurement data for interference detection support) is accessible via the CM, PM and FM metrics defined in 3GPP 32 series Technical Specifications. In addition, latency associated with the information flow from the higher-level network manager 504 to the eNodeBs 502 limits the possible time-resolution for network optimizations. Therefore, the SSCC 610 may implement standardized or proprietary low latency interfaces, shown as dashed lines 612 in FIG. 6, to the eNodeBs 502, or to EMs 508 that are implemented within eNodeBs, such as EM 508a which is implemented within base station 502a in FIG. 6.

Access to real-time information from the low-latency interfaces 612 allows the SSCC 610 to perform fast time-scale optimization of parameters of base stations 502. However, performing optimizations for an entire network or large portion of a network from a single central node 610 may place an excessive processing burden on certain central nodes 610. In addition, high-resolution optimizations from a global perspective for an entire network may be prohibitively complex. Therefore, a hybrid implementation in which some SC-SON functionality is distributed across the network may be used.

FIG. 7 shows an embodiment of an LTE based hybrid SC-SON system 700, in which aspects of SC-SON system 400 are distributed across multiple physical entities. System 700 includes a centralized component 720 that coordinates the SC-SON functionality of the distributed SC-SON components. The centralized component is referred to here as the SC-SON Central Controller (SSCC) 720.

With reference to FIG. 4, in an embodiment, some or all of the interference detection/classification module 402, performance assurance module 404 and interference mitigation module 406 are distributed across multiple physical entities in the system. The SSCC 720 may implement at least a portion of the modules, and may implement some or all of the other components of SC-SON system 400 including external database 410, spectrum policy database 412, geolocation module 414 and RF coverage prediction engine 416.

Distributed SON components, referred to here as SC-SON agents 716 and represented as black circles in FIG. 7, may reside in different network elements such as network manager 504, domain manager 506, element manager 508 and base station 502. Each of the SC-SON agents may implement a portion of at least one of the interference detection/classification module 402, performance assurance module 404 and interference mitigation module 406.

In an embodiment, the SC-SON functionalities implemented in the SSCC 720 may use global intelligence about the network and attempt to create slower-time-scale parameter adaptation policies that are optimized with respect to global objectives such as maximizing the total capacity of a secondary network 350 in the presence of interference from a primary network 300. Such global optimized adaptation policies may then be pushed down to the SC-SON agents 716 at the network elements.

Since the optimizations performed by the SSCC 720 may not have high resolution and may not operate on a fast time-scale, the SSCC need not necessarily have direct low-latency interfaces to network elements such as base stations 502. Thus, in an embodiment of a hybrid SC-SON system 700, aspects of SC-SON which benefit from rapid reporting and analysis of network data may be located at various network entities that are sources of or are close to sources of the network data, while less time-critical aspects of the SC-SON system may be located at SSCC 720. In various embodiments, SSCC 720 may be incorporated into Network Manager 504, or be a separate physical entity as shown in FIG. 7.

In an embodiment, the portions of the interference detection/classification module 402, performance assurance module 404 and interference mitigation module 406 located at SON agents 716 may use local information and optimize local parameters with regards to the local environment and the policy pushed down by the SSCC 720. Some portion of SC-SON agents 716 may have direct, possibly standardized, low-latency connections to the network elements such as base stations 502. In some networks, base stations 502 may also have direct low-latency connections to each other, such as the X2 interface shown in the LTE network of FIG. 7. Such low-latency interfaces facilitate the availability and access of real-time information at SC-SON agents 716, enabling SC-SON agents 716 to implement high-resolution optimization of network element parameters on a faster time-scale.

A hybrid system 700 reduces the complexity of optimizations by distributing the optimization process across the network. Distribution of the optimization process also reduces the information that needs to be exchanged across the network even for fast time-scale optimizations, since all the local information need not be sent to the SSCC 720.

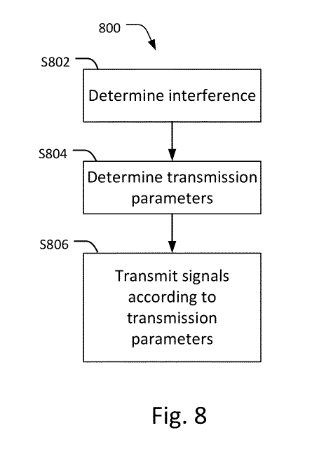

FIG. 8 illustrates an embodiment of a spectrum coexistence process 800. Elements of spectrum coexistence process will be explained with reference to an embodiment in which the primary network 300 is a broadcast television network, and the secondary network 350 is a LTE telecommunications network.

An SC-SON system determines interference at S802. In an embodiment, determining interference S802 includes determining interference from the primary network 300 to the secondary network 350. For example, the SC-SON system may search a database of users of a portion of spectrum that is the same as or near to a portion of spectrum used by a communications network coupled to the SC-SON system.

In more detail, the SC-SON system may search a database of registered spectrum users to determine which portions of spectrum are being used by primary networks 300 in various regions. For example, the SC-SON system may determine which channels are being broadcast in a given area, so that elements of the secondary network 350 in the given area can use portions of spectrum that do not interfere with the known broadcasts.

Interferers may be identified by determining frequencies and locations of RF signals from the primary network 300 that are sufficient to interfere with the secondary network 350. For example, signal strength is greatest at the location of the transmitter, and diminishes with distance. Therefore, determining interference may include determining signal levels from the primary network at various geographic locations that are used by the secondary network 350. In particular, the SC-SON may identify signal levels that are sufficient to cause interference to elements of the secondary network 35 at particular locations. Because signal strength varies according to location, the SC-SON system 400 may apply different levels of interference mitigation at different locations of the secondary network 350.

In an embodiment, determining interference S802 includes measuring signals at an element of the secondary network 350. For example, a base station 502 may measure signals that are received at particular frequencies during times at which no transmissions are scheduled for the secondary network 350. If no silent times of sufficient length are available in a transmission schedule, the SC-SON system may deliberately schedule silent times for the interference measurements as described in U.S. application Ser. No. 13/902,746. When interference is measured by the secondary network 350, it may be classified according to various signal characteristics, such as a portion of spectrum, a signal strength value at a particular location, and patterns with respect to time and frequency. The signal characteristics may be matched to a known source of interference based on similarities in the patterns, and classified signal characteristics may be stored in interference database 410.

Transmission parameters for the secondary network 350 are determined at S804. Determining transmission parameters may include applying a spectrum policy from spectrum policy database 412. For example, a transmission policy may be for the secondary network 350 to cause no interference to the primary network 300, in which case transmission parameters are determined to ensure that the secondary network does not transmit at frequencies and times that would interscafere with the primary network. In another embodiment, the transmission policy may include QoS parameters for one or both of the primary network 300 and the secondary network 350. In the example of the television network, transmission parameters may be determined so that users can receive television broadcast signals free of interference from the secondary telecommunications network.

After transmission parameters are determined at S804, signals are transmitted by the secondary network 350 according to the transmission parameters at S806. The transmission parameters may be parameters for a network element of the secondary network, such as a base station or user equipment.

In an embodiment, process 800 is performed by central SC-SON system 600 illustrated in FIG. 6. In such an embodiment, determining interference S802 and determining transmission parameters S804 are performed by SSCC 610 at a central location of the secondary network 350. In an embodiment with a SC-SON system 600, signals may be measured by base stations 502 and transmitted to SSCC 610 for classification. Data such as measured signals and transmission parameters may be communicated between SSCC 610 and other network elements by low latency connections, such as a connection with a latency of one second or less.

In another embodiment, process 800 is performed by hybrid SC-SON system 700 illustrated in FIG. 7. In such an embodiment, aspects of process 800 are performed by SSCC 720 at a central location, while other aspects of process 800 are performed by SON agents 716 distributed through the secondary network 350. For example, transmission parameters may be determined by SON agents 716 at base stations 502 or element managers 508 based on a spectrum policy parameters from a spectrum policy database in SSCC 720. Thus, processes that benefit from low latency to transmitters and receivers may be distributed through the network, while processes that are less sensitive to delay may be performed at a central network location.

What is claimed is:

1. A spectrum coexistence method comprising:
determining interference from a primary network to a secondary network that is independent from the primary network;
determining transmission parameters for a network element of the secondary network that mitigate interference from the secondary network to the primary network; and
transmitting signals from the network element according to the determined transmission parameters.

2. The method of claim 1, wherein determining interference to the secondary network includes searching a database of external interference.

3. The method of claim 2, wherein the database of external interference includes data for a plurality of predetermined interference sources that are known to transmit RF signals that interfere with the secondary network.

4. The method of claim 2, wherein determining interference to the secondary network includes:
measuring, by an element of the secondary network, signals that interfere with the secondary network; and
classifying the measured signals by one or more characteristic of the signals,
wherein the classified signal is used to determine the transmission parameters.

5. The method of claim 4, further comprising:
adding the classified signal to the database of external interference.

6. The method of claim 1, wherein determining interference from the primary network includes localizing a source of the interference by a geolocation engine of the secondary network.

7. The method of claim 1, wherein determining transmission parameters includes applying a spectrum policy from a spectrum policy database of the first network.

8. The method of claim 1, wherein determining transmission parameters includes performing a simulation with an RF coverage prediction engine included in the secondary network.

9. The method of claim 1, wherein determining the interference and determining transmission parameters for the network element are performed by a central network element using information from an Operation, Administration and Maintenance system, and the central network element is coupled to a plurality of base stations through low latency connections.

10. The method of claim 1, wherein performing determining transmission parameters is distributed between a plurality of Self Organizing Network (SON) agents disposed at various network elements based on spectrum policy parameters stored at a central network element.

11. A spectrum coexistence system comprising:
a plurality of base stations;
a performance assurance module that receives network performance data for a first network that includes the plurality of base stations;
an interference detection and classification module that determines interference to the spectrum coexistence system from an independent network that is independent from the first network; and
an interference mitigation module that determines transmission parameters for the plurality of base stations that mitigate interference from communications with the plurality of base stations to the independent network.

12. The spectrum coexistence system of claim 11, further comprising:
an external interference database that stores data for a plurality of predetermined interference sources that are known to transmit RF signals that interfere with the secondary network.

13. The spectrum coexistence system of claim 12, wherein the interference detection and classification module classifies signals from the independent network, and
wherein the interference mitigation module uses the classified signals from the independent network to determine the transmission parameters.

14. The spectrum coexistence system of claim 13, wherein the classified signals are stored in the external interference database.

15. The spectrum coexistence system of claim 11, further comprising:
a geolocation engine that localizes interference from the independent network.

16. The spectrum coexistence system of claim 11, further comprising:
a spectrum policy database that includes spectrum coexistence policy data for limiting interference from the plurality of base stations to the independent network.

17. The spectrum coexistence system of claim 11, further comprising an RF coverage prediction engine that performs a simulation of the transmission parameters, and changes the transmission parameters based on a result of the simulation.

18. The spectrum coexistence system of claim 11, wherein the performance assurance module, the interference detection module, and the interference mitigation module are disposed in a central network element that is coupled to the plurality of base stations through a low latency connection.

19. The spectrum coexistence system of claim 11, wherein portions of the performance assurance module, the interference detection module, and the interference mitigation module are distributed across a plurality of network elements, and
wherein a spectrum policy database and an external interference database are disposed in a central network element.

20. The spectrum coexistence system of claim 11, wherein the interference detection and classification module collates measurements from the plurality of base stations in order to detect and classify interference from the independent network.
